(19) United States
(12) Patent Application Publication
(10) Pub. No.: US 2020/0073586 A1
(43) Pub. Date: Mar. 5, 2020

(54) INFORMATION PROCESSOR AND CONTROL METHOD

(71) Applicant: Hitachi, Ltd., Tokyo (JP)

(72) Inventors: Naruki KURATA, Tokyo (JP); Hiroki FUJII, Tokyo (JP); Masahiro TSURUYA, Tokyo (JP)

(21) Appl. No.: 16/292,490

(22) Filed: Mar. 5, 2019

(30) Foreign Application Priority Data
Aug. 31, 2018 (JP) 2018-162817

(51) Int. Cl. G06F 3/06; G06F 12/02

(52) U.S. Cl. CPC G06F 3/0658; G06F 3/0652; G06F 3/0683; G06F 3/064; G06F 12/0253

(57) ABSTRACT

An information processing apparatus includes a storage controller and a storage device. The storage controller manages a first address space in which data is recorded in a log-structured format in response to a write request from a host. The storage device manages a second address space in which data is recorded in a log-structured format in response to a write request from the storage controller. The storage controller sets a unit by which the storage controller performs garbage collection in the first address space to a multiple of a unit by which the storage device performs garbage collection in the second address space.

### CROSS-REFERENCE TO RELATED APPLICATION

The present application claims priority from Japanese application JP 2018-162817, filed on Aug. 31, 2018, the contents of which is hereby incorporated by reference into this application.

### BACKGROUND

The present invention relates to an information processing apparatus that operates in consideration of the characteristics of a storage medium and a control method for the same.

In order to reduce the data drive purchase costs for storages, storage controllers installed with compression and deduplication functions become mainstream. Specifically, an all flash array (AFA) that is used as primary storage is installed with a solid state drive (SSD), and a flash memory (FM) that is the data storage medium of the SSD is expensive. Therefore, compression and deduplication functions are increasingly important.

In storage controllers installed with compression functions, compressed data is variable in length, and thus the same parts are not always rewritten to the same area. Therefore, typically, a block address from a host system is converted, and the converted data is stored in a log-structured format on a control space in the inside of the storage controller.

At this time, after data is updated, old data is invalidated to be garbage that is unused. In order to use this garbage space again, the storage controller moves valid data in a certain unit of size, which is called garbage collection (GC) to create free spaces. This GC is performed independently of writes from the host system.

In order to reduce bit costs of FMs, multi level FMs are promoted in which multiple bits are stored on an FM NAND cell. The FM has constraints on the number of rewrites. Although the multi level FM reduces bit costs, the number of rewritable times on the FM is decreased. The FM has the characteristics that its quality is degraded as the accumulated number of rewrites is increased, and this causes an increase in read time.

No data can be overwritten to the FM due to the FM physical characteristics. In order to reuse the spaces on which data is once written, data has to be erased. Typically in the FM, an erase unit (referred to as a block) is greater than a write/read unit (referred to as a page). Therefore, the SSD includes a layer in which a logical address shown as the interface of a drive is converted into a physical address for actual access to the FM and data is written to the FM in a log-structured format. In writing data, the old data at the same logical address is left as garbage, and GC by the SSD is necessary to collect the data. As techniques that perform efficient GC, there is Japanese Unexamined Patent Application Publication No. 2016-212835. Japanese Unexamined Patent Application Publication No. 2016-212835 discloses a technique with which spaces with small valid data volumes are selected as GC targets and hence data migration is reduced.

### SUMMARY

As described above, the FM has constraints on the number of rewritable times. When the number of times of data migration in SSD GC is increased, FM degradation is advanced regardless of the write amount from the host system. Therefore, this shortens the lifetime of the SSD or this increases read time faster than as expected due to error correction. When data migration by GC collides with read/write processes by a storage controller, the read/write performances of the SSD are also degraded.

Units of GC performed by the storage controller can be freely set according to the circumstances of the storage controller. On the other hand, SSD GC has to be performed based on a multiple of the erase unit due to the FM physical configuration. These two types of GC are typically independently performed, and hence data migration by storage controller GC and data migration by SSD GC independently occur. The migrations double the number of rewrites to the FM, and further accelerate the degradation in the FM lifetime.

However, Japanese Unexamined Patent Application Publication No. 2016-212835 has no description on problems that cause both of storage controller GC and SSD GC.

Therefore, an object of the present invention is to provide an information processing apparatus that reduces data migration in SSD GC by setting the unit of GC performed by a storage controller to an integral multiple of the FM block of an SSD and a control method for the storage space of an information processing apparatus.

An information processing apparatus according to an aspect of the present invention preferably includes a storage controller, and a storage device. The storage controller manages a first address space in which data is recorded in a log-structured format in response to a write request from a host. The storage device manages a second address space in which data is recorded in a log-structured format in response to a write request from the storage controller. The storage controller sets a unit by which the storage controller performs garbage collection in the first address space to a multiple of a unit by which the storage device performs garbage collection in the second address space.

An information processing apparatus according to another aspect of the present invention preferably includes a storage controller, and at least two storage devices. The storage controller has a first address space in which data is recorded in a log-structured format in response to a write request from a host, the first address space being managed in a segment unit. The storage device has a second address space in response to a write request from the storage controller in which data is recorded in a log-structured format, the second address space being managed in a parity group unit. In the first address space, the storage controller performs garbage collection in the segment unit, and in the second address space, the storage device performs garbage collection in a unit of the parity group. The storage controller sets the segment unit to a multiple of the unit of the parity group.

A control method for the storage space of the information processing apparatus according to an aspect of the present invention preferably includes: managing, by the storage controller, a first address space in which data is recorded in a log-structured format in response to a write request from a host; managing, by the storage device, a second address space in which data is recorded in a log-structured format in response to a write request from the storage controller; and setting, by the storage controller, a unit by which the storage controller performs garbage collection in the first address space to a multiple of a unit by which the storage device performs garbage collection in the second address space.

According to the aspects of the present invention, a reduction in data migration due to garbage collection enables an increase in the lifetime of the SSD, and a reduction in error correction processing due to the shortened lifetime of the SSD, for example, enables the improvement of performances as well.

### BRIEF DESCRIPTION OF THE DRAWINGS

FIG. 1 is a diagram of the structure of a computer system including a storage system;

FIG. 2 is a diagram of the internal structure of an SSD;

FIG. 3 is a diagram of the hierarchical structure of the storage area of the storage system;

FIG. 4 is a diagram of tables that manage address mapping information on a storage controller;

FIG. 5 is a diagram of the structure of a write request issued to the storage controller by a host computer;

FIG. 6 is a diagram of the logical structure of address mapping by the storage controller in writing new data;

FIG. 7 is a diagram of the logical structure of address mapping by the storage controller when data is overwritten;

FIG. 8 is a flowchart of a write request process by the storage controller;

FIG. 9 is a diagram of the logical structure of address mapping by the storage controller when garbage collection is performed;

FIG. 10 is a flowchart of a garbage collection process by the storage controller;

FIG. 11 is a diagram of tables used for managing address mapping information on the SSD;

FIG. 12 is a diagram of the structure of a write request issued to an SSD by the storage controller;

FIG. 13 is a diagram of the logical structure of address mapping on an SSD in writing new data;

FIG. 14 is a flowchart of a write request process on an SSD;

FIG. 15 is a flowchart of a garbage collection process on an SSD;

FIG. 16 is a diagram of the logical structure of address mapping between the storage controller and an SSD focusing attention on segments in a previously existing technique;

FIG. 17A is a diagram of new write to an SSD in which attention is focused on segments in a previously existing technique;

FIG. 17B is a diagram of overwrite to the SSD in which attention is focused on segments in a previously existing technique;

FIG. 17C is a diagram of garbage collection on the SSD in which attention is focused on segments in a previously existing technique;

FIG. 18 is a flowchart of a segment creating process by the storage controller;

FIG. 19 is a diagram of the logical structure of address mapping between the storage controller and an SSD in adjusting the segment size;

FIG. 20 is a diagram of a new write and an overwrite to the SSD in adjusting the segment size of the storage controller;

FIG. 21 is a flowchart of an unmapping process on an SSD; and

FIG. 22 is a diagram of a new write and an unmapping process to an SSD to which over-provisioning is not performed by the storage controller.

### DETAILED DESCRIPTION

In the following, embodiments of the present invention will be described in detail with reference to the drawings. Note that the embodiments are examples that implement the present invention and will not limit the technical scope of the present invention. In the drawings, common configurations are designated with the same reference numbers.

### First Embodiment

In the following, a first embodiment of the present invention will be described with reference to the drawings. The following description and drawings are examples for explaining the present invention, and some parts are appropriately omitted and simplified for accurate description. The present invention can be performed in various other forms. One component or multiple components will be used unless otherwise specified.

The actual locations, sizes, shapes, and ranges, for example, of the components are not sometimes described for easy understanding of the present invention. Thus, the present invention is non-limiting to the locations, sizes, shapes, and ranges, for example, disclosed in the drawings.

In the following description, various pieces of information will be described by the terms “table”, “list”, and “queue”, for example. However, various pieces of information may be described by data structures other than these terms. In order to show no dependence on data structures, “an XX table”, and “an XX list”, for example, are sometimes referred to as “XX information”. In the description of identification information, the terms “identification information”, “identifier”, “name”, “identification (ID)”, and “number”, for example, are used, and they can be replaced by each other.

In the case in which there are many components having the same or similar functions, these components sometimes described with the same reference signs having different subscripts. However, in the case in which there is no need to distinguish between these components, the components are sometimes described with subscripts omitted.

In the following description, processes performed by executing programs are sometimes described. Since the programs execute predetermined processes with appropriate use of storage sources (e.g. memories), interface devices (e.g. communication ports), or storage sources and interface devices, for example, by the operation of a processor (e.g. a central processing unit (CPU) or graphics processing unit), the entity of the processes may be a processor. Similarly, the entity of the processes executed by the programs may be a controller, device, system, computer, and node that include a processor. The entity of the processes executed by the programs only has to be an operating unit, and may include a dedicated circuit that performs a specific process (e.g. a field programmable gate array or application specific integrated circuit).

The programs may be installed on a device, such as a computer from a program source. The program source may be a program distribution server or computer readable storage medium, for example. In the case in which the program source is a program distribution server, the program distribution server includes a processor and storage sources that store a distribution target program. The processor of the program distribution server may distribute the distribution target program to another computer. In the following description, two or more programs may be implemented as one program, or one program may be implemented as two or more programs.

### <Outline of System Configurations>

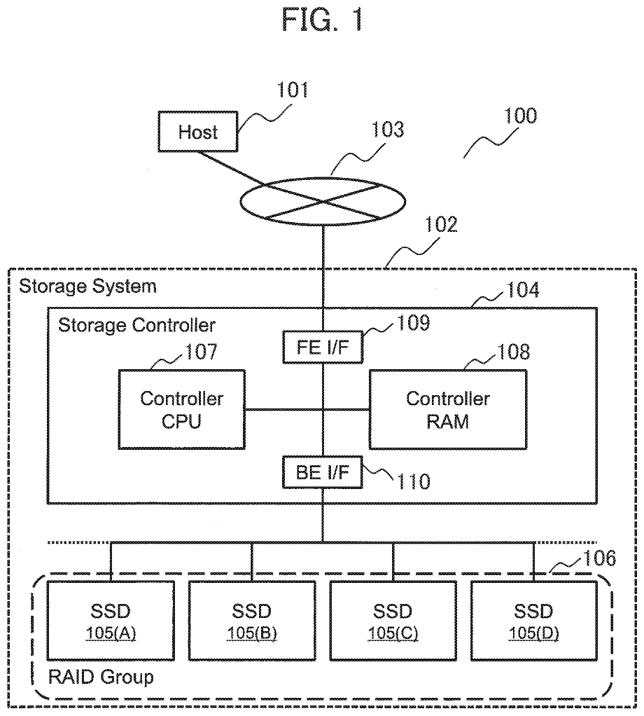

FIG. 1 is the outline of a computer system 100 including an embodiment of the present invention. The computer system 100 has a host computer 101 and a storage system 102. The host computer 101 is connected to the storage system 102 via a network 103. The network 103 is a storage area network (SAN) formed using fiber channels, for example. The network 103 may be a protocol that can transfer small computer system interface (SCSI) commands or may use other input/output protocols.

The host computer 101 is a computer that execute the user application programs and makes access to the logical storage area of the storage system 102 via the network 103. The storage system 102 stores data on and retrieves stored data from the SSD 105 according to a request from the host computer.

Note that in the first embodiment, one host computer 101 and one storage system 102 are provided. However, at least two host computers 101 may be connected to the storage system 102 via the network 103, or at least two storage systems 102 form a redundant configuration. The functions of the host computer 101 and the storage system 102 can also be implemented by one or at least two computers using the same hardware resources like a software defined storage (SDS).

The storage system 102 has a storage controller (or simply referred to as a controller) 104 and SSDs 105. The storage controller 104 has a controller central processing unit (CPU) 107, a controller random access memory (RAM) 108, a front end Interface (FE I/F) 109, and a Backend Interface (BE I/F) 110. The components of the storage controller 104 are connected to each other through a bus.

The controller RAM 108 includes a space that stores a program and metadata for controlling the storage system 102 operating on the controller CPU 107 and a cache memory that temporarily stores data. For the controller RAM 108, a volatile storage medium, such as a dynamic random access memory (DRAM), is typically used, but a non-volatile storage medium may be used. The storage controller 104 according to the first embodiment has a compression function by hardware (not shown) or software. However, the storage controller 104 does not necessarily has any compression function.

The FE I/F 109 is an interface connected to the network 103. The BE I/F 110 is an interface connected to the SSD 105. In the first embodiment, the storage system 102 controls at least two storage media as a RAID group (RG) 106 using the function of the redundant array of independent (inexpensive) disks (RAID). For example, in FIG. 1, SSDs 105(A), 105(B), 105(C), and 105(D) are configured as RGs. However, the embodiment of the present invention is effective without the function of configuring RGs in the storage system 102.

The SSD 105 includes a non-volatile storage medium that stores write data from the host computer 101. Examples of the storage medium that can be used include a flash memory and may use other media.

### <Outline of the SSD>

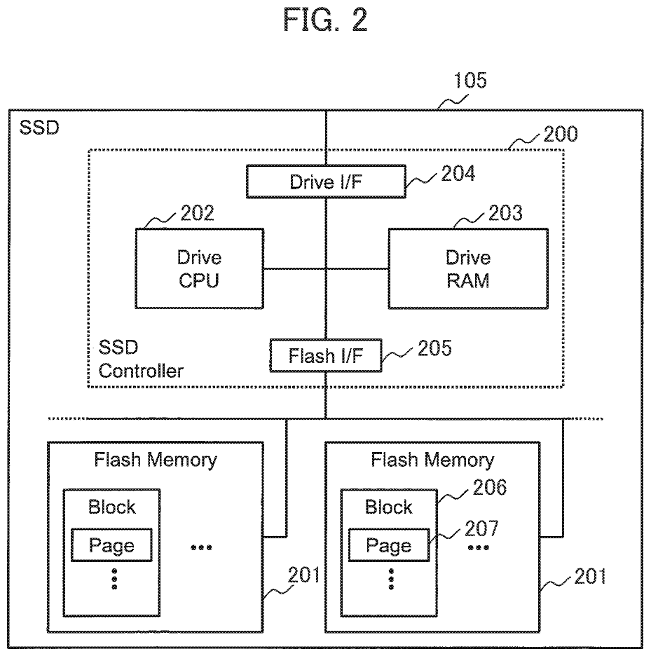

FIG. 2 is the internal configuration of the SSD (Solid State Drive) 105 that is a storage device. The SSD 105 has an SSD controller 200 and a flash memory 201. The SSD controller 200 has a drive CPU 202, a drive RAM 203, a drive I/F 204, and a flash I/F 205. The components of the SSD controller are connected to each other through a bus. The SSDs 105 are installed with at least two flash memories 201. However, the SSDs 105 may have one flash memory 201.

The drive RAM 203 includes a space that stores programs and metadata for controlling the SSDs operating on the drive CPU 202 and a space that temporarily stores data. For the drive RAM 203, a volatile storage medium, such as a DRAM is typically used. However, a non-volatile storage medium may be used.

The drive I/F 204 is an interface connected to the storage controller 104. The flash I/F is an interface connected to the flash memory 201. The data storage space of the flash memory 201 has at least two blocks 206 that are erase units. The block 206 has pages 207 that are read/write units.

### <Outline of the Hierarchical Structure of the Storage Area>

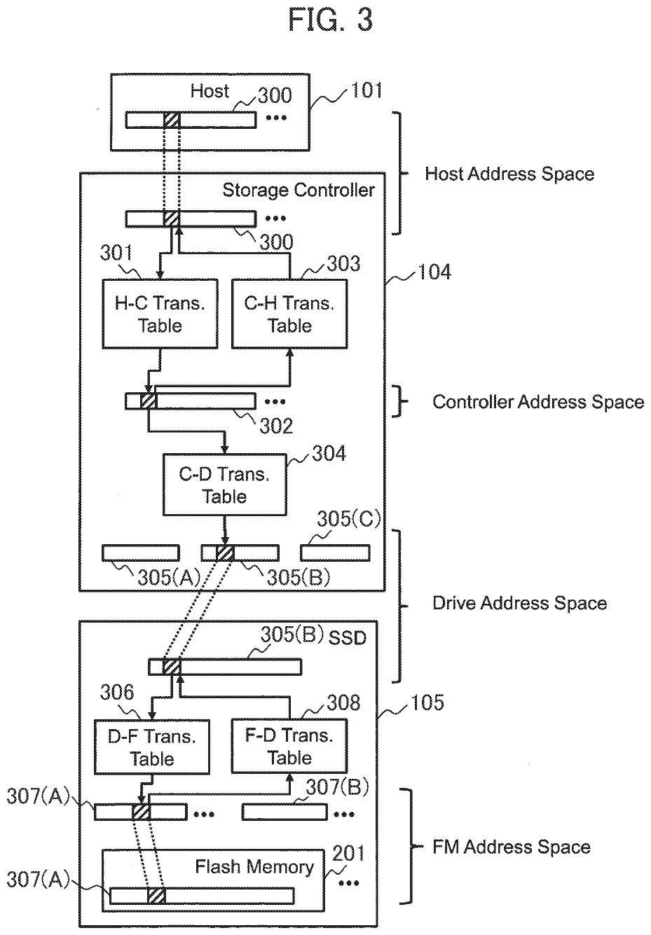

FIG. 3 is an example schematically illustrating the hierarchical structure of the storage areas according to the first embodiment. A host address space 300 is the address space of the storage controller 104 recognized by the host computer 101. In the first embodiment, one host address space 300 is provided which the host computer 101 is recognized by the storage controller 104. However, at least two host address spaces 300 may be provided. The storage controller manages the host address space, and provides the space 300 as an address space to the host 101. The host address space 300 is mapped on a controller address space 302 according to an H-C translation table 301 of the storage controller 104. The controller address space 302 is a space in a log-structured format in which data is stored packed to the beginning in order of receiving write requests. The controller address space 302 is mapped to the host address space 300 according to the C-H translation table 303. The drive address space 305 is the address spaces of the SSDs recognized by the controller. A C-D translation table 304 maps addresses from the controller address space 302 to the SSDs 105 and the SSD drive address spaces 305.

The host address space 300, the controller address space 302, and the drive address space 305 are managed by the storage controller 104, and are in association with the addresses of the layers according to the various translation tables (the H-C translation table 301, the C-H translation table 303, and the C-D translation table 304) described above.

A D-F translation table 306 maps addresses from the drive address space 305 to the flash memory 201 and an FM address space 307 of the flash memory 201. The SSD controller 200 for the SSD 105 manages the FM address space 307. An F-D translation table 308 maps addresses from the FM address space 307 to the drive address space 305.

The H-C translation table 301, the C-H translation table 303, and the C-D translation table 304 are typically stored on the controller RAM 108. However, these tables may be partially stored on the SSD 105. The D-F translation table 306 and the F-D translation table 308 are typically stored on the drive RAM 203. However, these tables may be partially stored on the flash memory 201.

The drive address space 305 and the FM address space 307 are managed by the SSD controller 200 for the SSD 105, and are in association with the addresses of the layers according to the D-F translation table 306 and the F-D translation table 308.

Note that the embodiment of the present invention is non-limiting to the hierarchical structure in FIG. 3. The storage controller 104 may further include a hierarchy on the host side or the drive side of the controller address space 302 or the host side and the drive side of the controller address space 302. The SSD may further include a hierarchy between the drive address space 305 and the FM address space 307.

### <Detail of the Address Translation Tables in the Storage Controller>

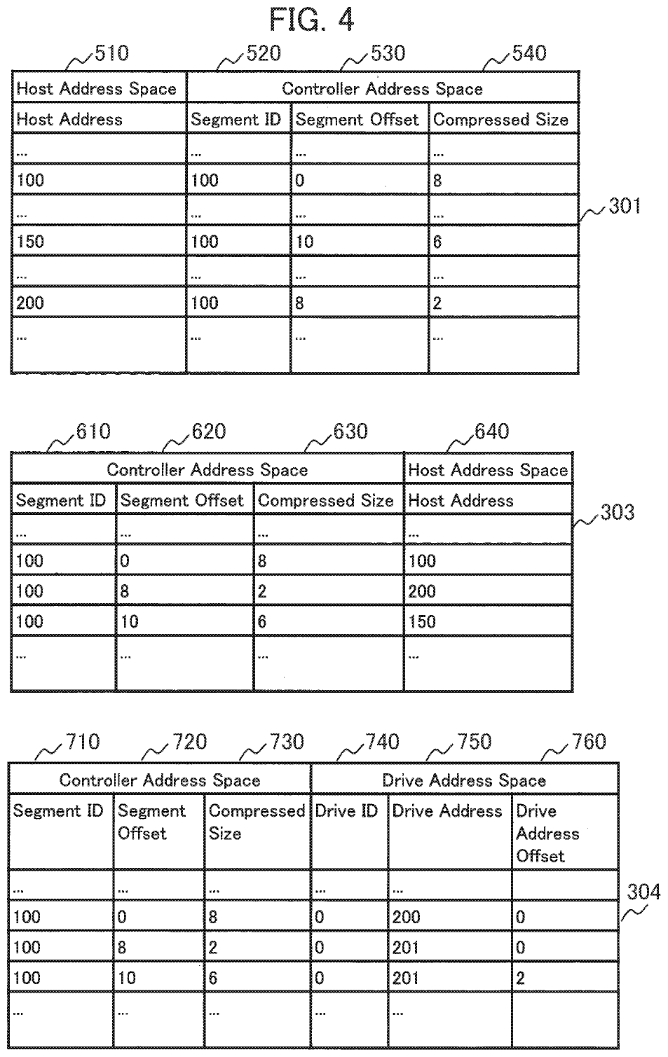

FIG. 4 is a diagram of the detail of the H-C translation table 301, the C-H translation table 303, and the C-D translation table 304 of the storage controller 104. The H-C translation table 301 has, as fields, a host address 510, and a segment ID 520, a segment offset 530, and a compressed size 540 of the controller address space 302. The host address 510 expresses a location in the host address space 300. The host address 510 is a block address, for example. The segment ID 520 is a number that uniquely expresses a segment (the detail will be described later) allocated to the controller address space 302 in a certain size. The segment offset 530 shows the beginning location in the data segment expressed by the row.

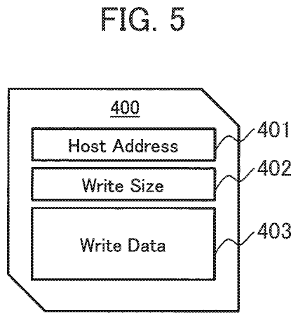

The location in the controller address space is expressed by the segment ID 520 and the segment offset 530. The compressed size 540 expresses the data size after data in the write request 400 (see FIG. 5) is compressed. These pieces of information can uniquely identify the location of the controller address to the host address.

For example, the host address 510 that is “100” is in association with the segment ID 520 that is “100”, the segment offset 530 that is “0”, and the compressed size 540 that is “8” in the controller address space 302.

The C-H translation table 303 has, as fields, a segment ID 610, a segment offset 620, a compressed size 630, and a host address 640 of the controller address space 302. The segment ID 610 is a number that expresses a segment allocated to the controller address space 302 in a certain size. The segment offset 620 shows the beginning location in the data segment expressed by the row. The location in the controller address space is expressed by the segment ID 610 and the segment offset 620. The compressed size 630 expresses the data size after data in the write request 400 (see FIG. 5) is compressed. The host address 510 expresses the location in the host address space 300.

For example, the host address 640 that is “100” is in association with the segment ID 610 that is “100”, the segment offset 620 that is “0”, and the compressed size 630 that is “8” in the controller address space 302.

The C-D translation table 304 has, as fields, a segment ID 710, a segment offset 720, and a compressed size 730 of the controller address space 302, and a drive ID 740, a drive address 750, and a drive address offset 760 of the drive address space 305. The segment ID 710 is a number that expresses a segment allocated to the controller address space 302. The segment offset 720 shows the beginning location in the data segment expressed by the row. The location in the controller address space is expressed by the segment ID 710 and the segment offset 720. The compressed size 730 expresses the data size after data in the write request 400 is compressed. The drive ID 740 is a number that uniquely expresses the SSD 105. The drive address 750 expresses the location in the drive address space 305 of the SSD 105 specified by the drive ID 740. The drive address offset 760 expresses the offset in the address specified by the drive address 750.

For example, the segment ID 710 that is “100” and the segment offset 720 that is “0” in the controller address space 302 are in association with the compressed size 730 that “8”, the drive ID 740 that is “0”, the drive address 750 that is “200”, and the drive address offset 760 that is “0” in the drive address space 305.

### <Outline of the Write Request Process and the Address Mapping in the Storage Controller>

FIG. 5 is an example of information when the host computer 101 requests the storage system 102 to write data. The write request 400 includes a host address 401, a write size 402, and write data 403.

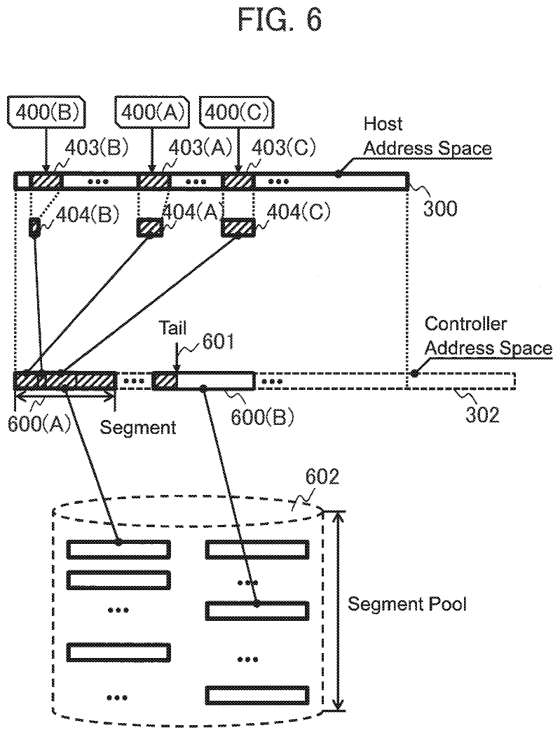

FIG. 6 is an example schematically illustrating the correspondence in address mapping by the controller according to the first embodiment. Here, for example, suppose that the host computer 101 requests write data in order of data 400(A), data 400(B), and data 400(C). In the first embodiment, the storage controller 104 that has the compression function compresses the requested write data 403(A), 403(B), and 403(C) to generate compressed data 404(A), 404(B), and 404(C), and then maps the compressed data on the host address space 300 and the controller address space 302. Specifically, the entries are added to the H-C translation table 301 and the C-H translation table 303. At this time, since the controller address space 302 has a log-structured format, data is stored from the beginning of the controller address in order of requests as shown in FIG. 6.

In the first embodiment, the storage controller 104 maps the controller address space 302 on the drive address space 305 on demand. The unit for data mapping is referred to as a segment 600. When the storage controller 104 reserves a new segment, the controller 104 selects a given segment from a virtual pool space referred to as a segment pool space 602, and maps the segment on the controller address space. The segment pool space 602 is a virtual pool that collectively manages the resources of the drive address space 305. The segment 600 is typically a space that cuts a part of the RG, and its size is 42 MB, for example.

The reservation of the segment 600, i.e., mapping from the controller address space 302 to the drive address space 305 is actually performed by updating the C-D translation table 304. The controller address space 302 has a controller address tail pointer 601 that indicates the last address where mapping is performed last. The write data from the host computer 101 is additionally written to the part indicated by the tail pointer.

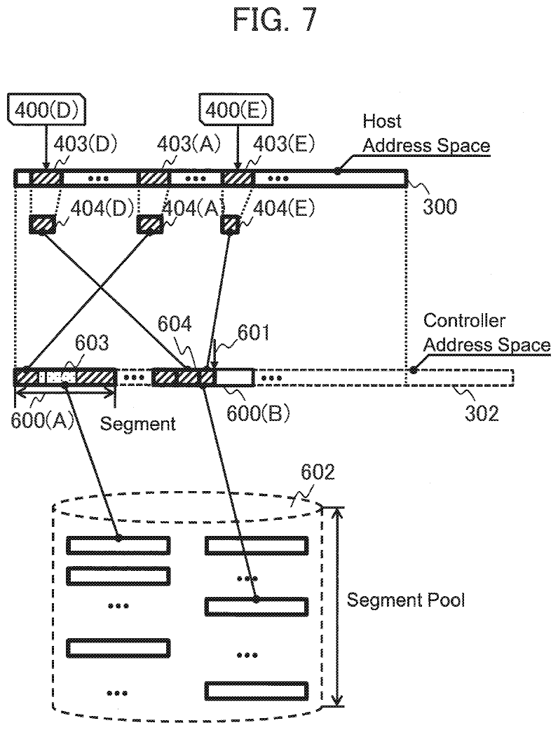

FIG. 7 schematically shows that the host computer 101 overwrites data from the state in FIG. 6. Suppose that the host computer 101 issues write requests 400(D) and 400(E) to the host addresses where the write data 403(B) and 403(C) are stored in FIG. 6. The storage controller 104 compresses the write data 403(D) and 403(E) to generate compressed data 404(D) and 404(E), and maps the compressed data on the controller address space 302. At this time, the controller address space 302 has a log-structured format as described above, and the data is mapped in order of writes as the controller address tail pointer 601 is the starting point. At this time, the H-C translation table 301 and the C-H translation table 303 are updated. However, although old data is mapped on the C-H translation table 303, no old data is mapped on the H-C translation table 301. That is, since no old data is mapped on the H-C translation table 301, the host 101 does not make reference. Since the new data and the old data are mapped on the C-H translation table 303, the correspondence between two controller addresses (controller garbage 603 and a partial segment 604 where the new data 404(D) is stored) to one host address (the address where the data 403(D) is stored) is managed.

The controller garbage 603 is generated every time when data is overwritten to the host address space 300. Then, although the host address space 300 has an enough remaining capacity, the situation occurs in which the write destination is run out on the controller address space 302 due to the garbage. The garbage collection (GC) is performed in order to prevent this problem. In order that the storage system can be operated even though the controller garbage 603 is accumulated to some extent, over-provisioning is typically performed in which the controller address space 302 is increased more than the host address space 300.

### <Write Request Process Flow of the Storage Controller>

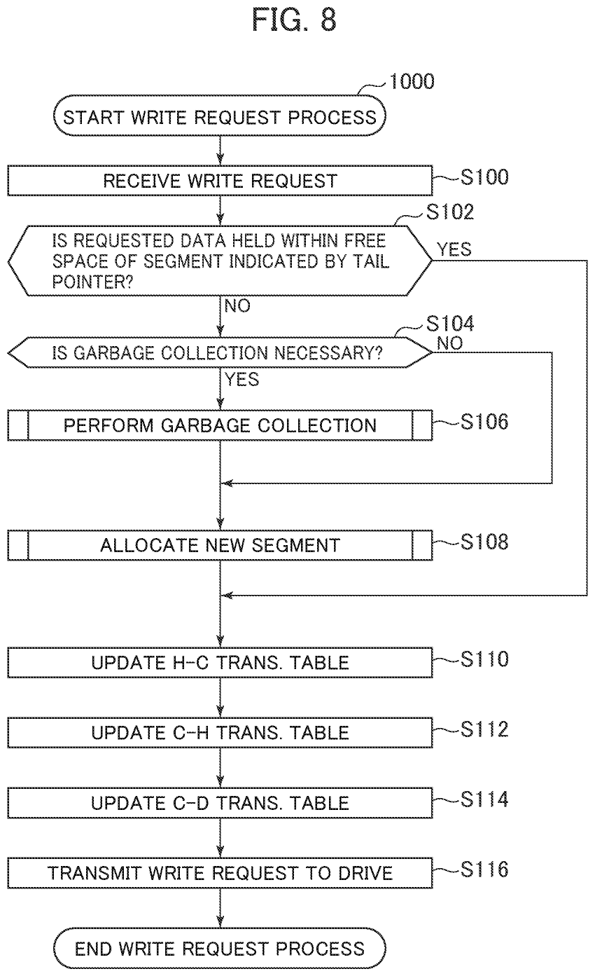

The procedure can be expressed in a flowchart performed by the storage controller 104 in FIG. 8. The items of the procedure are examples that is focused on processes between the write request 400 and the address spaces, and are non-limiting to the order and the process content.

In Step S100, the storage controller 104 receives a write request from the host computer 101 through the FE I/F 109. The write request includes a host address showing a write destination, the size to write data, and data to be written, for example.

In Step S102, it is determined whether the write-requested data fits into the free space of the segment 600 indicated by the controller address tail pointer 601.

In the case in which the data fits into the free space, the procedure goes to Step S110.

In the case in which the data does not fit into the free space, the procedure goes to Step S104.

In Step S104, it is determined whether GC has to be performed. Examples of determination thresholds that can be considered include the case in which the used capacity of the storage system 102 is 90% or more, or the case in which the free capacity is 100 GB or less, for example. The other thresholds may be fine. The important thing here is to avoid the situations in which although there is a sufficient free capacity when the host computer 101 sees the space, no new segment is allocated due to the controller garbage 603 and hence storage system operation fails.

In the case in which GC is unnecessary, the procedure goes to Step S108.

In the case in which GC is necessary, the procedure goes to Step S106.

In the case in which the write request process is performed as the process in GC by the storage controller 104, described later, it is determined that GC is unnecessary.

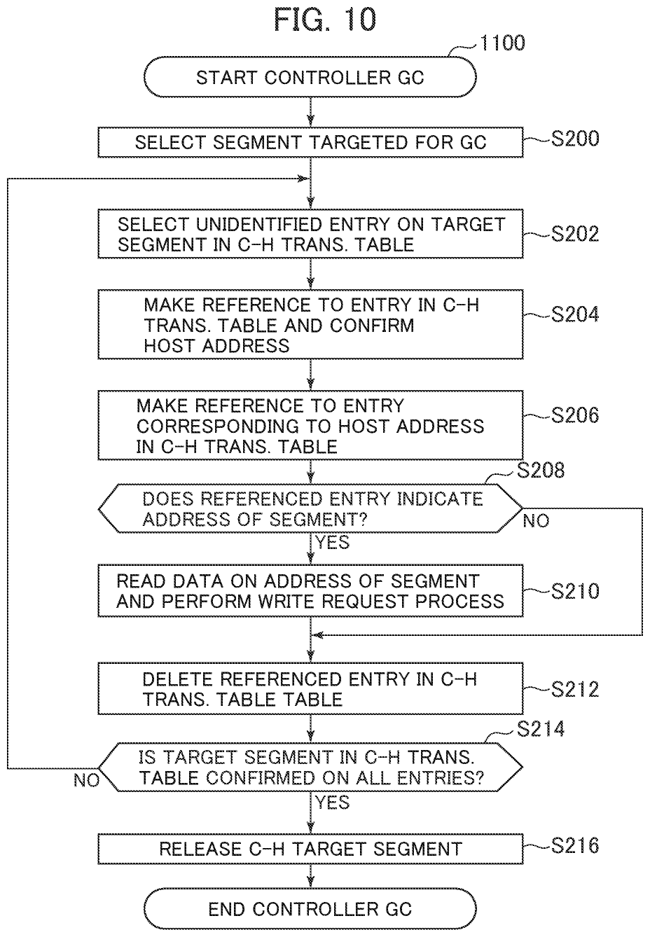

In Step S106, the storage controller 104 performs GC. The detail of GC will be described later in detail in a process 1100 in FIG. 10.

In Step S108, the storage controller 104 allocates a new segment 600 from the pool 602.

In Step S110, the H-C translation table 301 is updated. Specifically, first, a row corresponds to the host address indicated by the write request 400 is selected from the host address 510 of the H-C translation table 301. After that, the entries in the corresponding row are rewritten to the segment ID 520, the segment offset 530, and the compressed size 540 indicated by the controller address tail pointer 601, corresponding to the controller address space 302 where a write is performed.

In Step S112, in order to update the C-H translation table 303, first, a new row is reserved on the C-H translation table 303. Subsequently, the segment ID 610, the segment offset 620, and the compressed size 630 indicated by the controller address tail pointer 601 that correspond to the controller address space 302 and the host address 640 indicated by the write request 400 are written to the row reserved on the C-H translation table 303.

In Step S114, in order to update the C-D translation table 304, first, a new row is reserved on the C-D translation table 304. Subsequently, the segment ID 710, the segment offset 720, the compressed size 730, the drive ID 740, the drive address 750, and the drive address offset 760 indicated by the controller address tail pointer 601, corresponding to the controller address space 302 are written to the row reserved on the C-D translation table 304.

In Step S116, the write request is sent to the drive address written in Step S114 through the BE I/F.

### <Storage Controller GC>

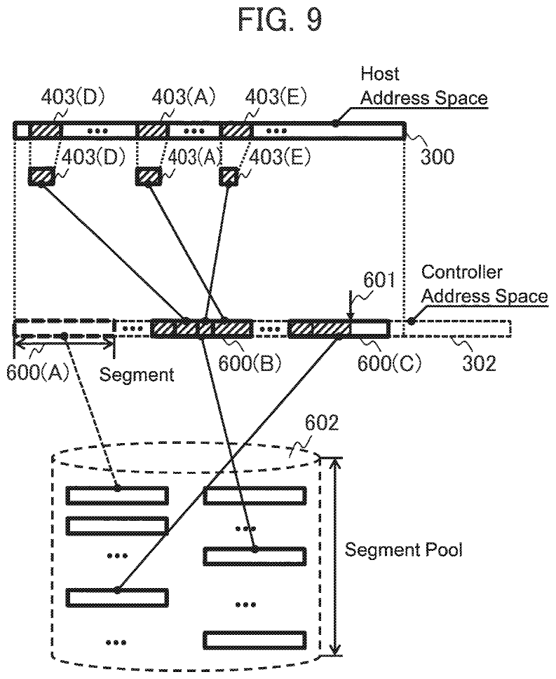

FIG. 9 schematically shows GC by the storage controller 104 from the state shown in FIG. 7. First, suppose that the storage controller 104 sets the segment 600A to a GC target. The storage controller 104 confirms whether each item of data in the target segment is valid. In the case in which the data is valid, the storage controller 104 writes the corresponding data to the part where the controller address tail pointer 601 is present, and updates the controller addresses in the H-C translation table 301, the C-H translation table 303, and the C-D translation table 304. On the other hand, in the case in which no data is valid, nothing is performed.

After the storage controller 104 confirms all the spaces in the segment 600A, the entire segment is the space where no access is made from the host address space 300, and hence the storage controller 104 releases the segment 600A. The storage controller 104 thus collects the garbage space by the operation above. Note that in addition to performing GC in the write request process, GC by the storage controller 104 may be performed at a given timing even in the case in which no request is made from the host computer 101.

### <Process Flow of Storage Controller GC>

The GC process procedure by the storage controller can be expressed by a flowchart 1100 in FIG. 10.

In Step S200, the storage controller 104 selects a segment that is a GC target. Examples of selecting the target segments that can be considered include a method that a segment is checked from the beginning of the controller address and if the ratio of garbage to all the spaces in the segment is 10% or more, the segment is selected. However, the other algorithms may be used.

In Step S202, the storage controller 104 selects an unchecked entry since GC is started on the segment selected in Step S200 from the C-H translation table 303. The unchecked entry means an entry showed in FIG. 4. Since at least two entries are present on one segment, an unchecked entry is selected.

In Step S204, the storage controller 104 makes reference to the entry selected by in Step S202, and refers the host address field 640.

In Step S206, the storage controller 104 selects the entry corresponding to the host address referred in Step S204 in the H-C translation table 301.

In Step S208, the storage controller 104 makes reference to the entry selected by in Step S206, and refers the segment ID 520 and the segment offset 530 that express the controller address.

When the referred controller address is matched with the controller address of the entry selected in Step S202, data stored on the controller address is valid, and the procedure goes to Step S210.

When the referred controller address is unmatched with the controller address of the entry selected in Step S202, data stored on the referred controller address is garbage, and the procedure goes to Step S212.

In Step S210, the storage controller 104 reads data stored on the controller address of the entry selected in Step S202, creates a write request 400 with the host address of the corresponding data, and performs the write request process 1000 shown in FIG. 8.

In Step S212, the storage controller 104 deletes the entry in the C-H translation table 303 selected in Step S202. However, the entries in the C-H translation table 303 may also be collectively deleted in a segment unit.

In Step S214, the storage controller 104 checks whether the entry of the GC target segment selected in Step S200 is present in the C-H translation table 303.

In the case in which the entry is present, the procedure returns to Step S202.

In the case in which no entry is present, the procedure goes to Step S216.

In Step S216, the storage controller 104 releases the GC target segment.

At this time, the storage controller 104 may notify the SSD 105 the release of the drive address. The release notification may be achieved by issuing a SCSI UNMAP command. Note that the process is not required in the case in which the controller address space 302 is over-provisioned. No release notification is the premise in the following description of the first embodiment.

### <Detail of the Address Translation Tables in the SSD Controller>

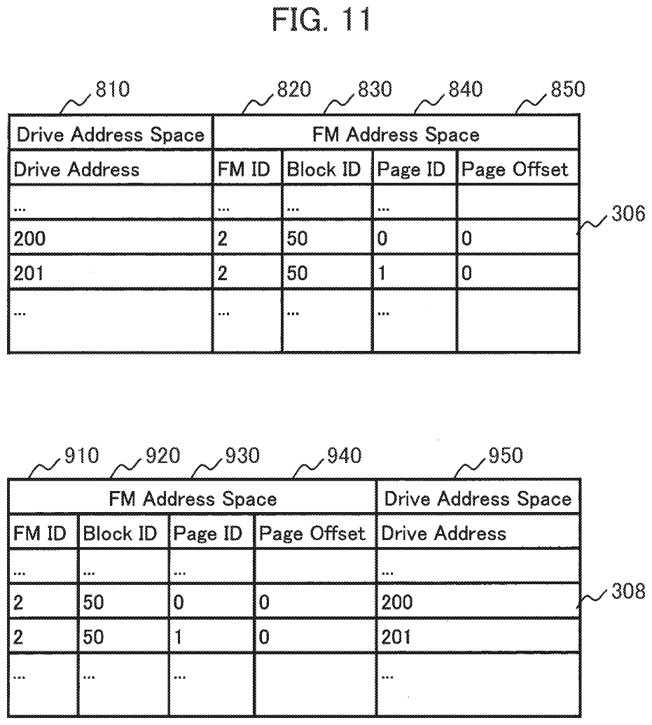

FIG. 11 is a diagram of the detail of the D-F translation table 306 and the F-D translation table 308 of the SSD 105. The D-F translation table 306 has, as fields, a drive address 810, an FM ID 820, a block ID 830, a page ID 840, and a page offset 850. The drive address 810 expresses a location in the drive address space 305 of the SSD 105. The FM ID 820 uniquely expresses an FM included in the SSD 105. The block ID 830 uniquely expresses a block in the FM indicated by the FM ID 820. The page ID 830 uniquely expresses a page in the block indicated by the block ID 830. The page offset 850 expresses a beginning location of the data expressed by the corresponding row in the page. The drive address 810 that is “200” in the drive address space 305 is in association with the FM ID 820 that is “2”, the block ID 830 that is “50”, the page ID 840 that is “0”, the page offset 850 that is “0” in the FM address space 307.

The F-D translation table 308 has, as fields, an FM ID 910, a block ID 920, a page ID 930, a page offset 940, and a drive address 950. The FM ID 910 uniquely expresses the FM included in the SSD 105. The block ID 920 uniquely expresses the block in the FM indicated by the FM ID 910. The page ID 930 uniquely expresses the page in the block indicated by the block ID 920. The page offset 940 expresses the beginning location of data expressed by the corresponding row in the page. The drive address 950 expresses the location in the drive address space 305 of the SSD 105.

### <Outline of the Write Request Process and the Address Mapping in the SSD>

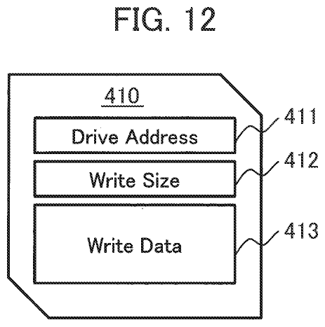

FIG. 12 shows an example of information when the storage system 102 requests the SSD 105 to write data. A write request 410 includes a drive address 411, a write size 412, and a write data 413.

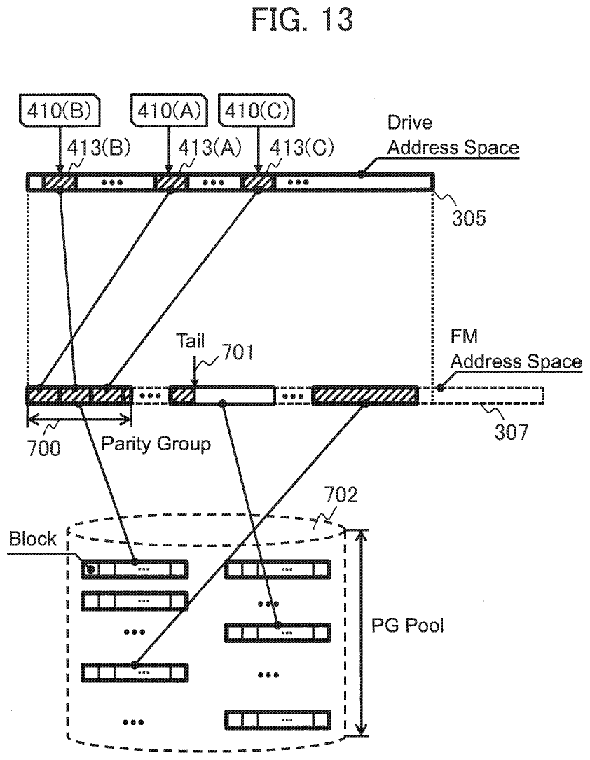

FIG. 13 is an example schematically illustrating the correspondence of address mapping in the SSD 105 according to the first embodiment. Here, for example, suppose that the storage controller 104 requests writes in order of data 410(A), data 410(B), and data 410(C). The SSD controller 200 maps the write data 413(A), 413(B), and 413(C) of the request on the drive address space 305 and the FM address space 307. Specifically, the entries are added to the D-F translation table 306 and the F-D translation table 308. In the first embodiment, the storage controller maps the drive address space 305 on the FM address space 307 on demand. The unit for mapping is referred to as a parity group (PG) 700. The PG 700 is a set including at least one given block of the FM. The set is provided because data erase performed in SSD GC, described later, is performed in a block unit due to FM physical constraints. When the SSD 105 reserves a new PG, a free PG is selected from a pool space referred to as a virtual PG pool space 702, and the free PG is mapped on the FM address space 307. The PG pool space 702 is a virtual pool that collectively manages the resources of the FM address space 307. The FM address space 307 has a log-structured format in a unit PG, and data is stored from the beginning of the FM address in order of requests.

The FM address space 307 has an FM address tail pointer 701 that indicates the last address where mapping is performed last. The write data from the storage controller 104 is additionally written to the part where the FM address tail pointer 701 is present. In order that the SSD can be operated even though garbage is accumulated to some extent, similarly to the storage controller 104, over-provisioning is typically performed in which the FM address space 307 is increased more than the drive address space 305.

### <Write Request Process Flow of the SSD>

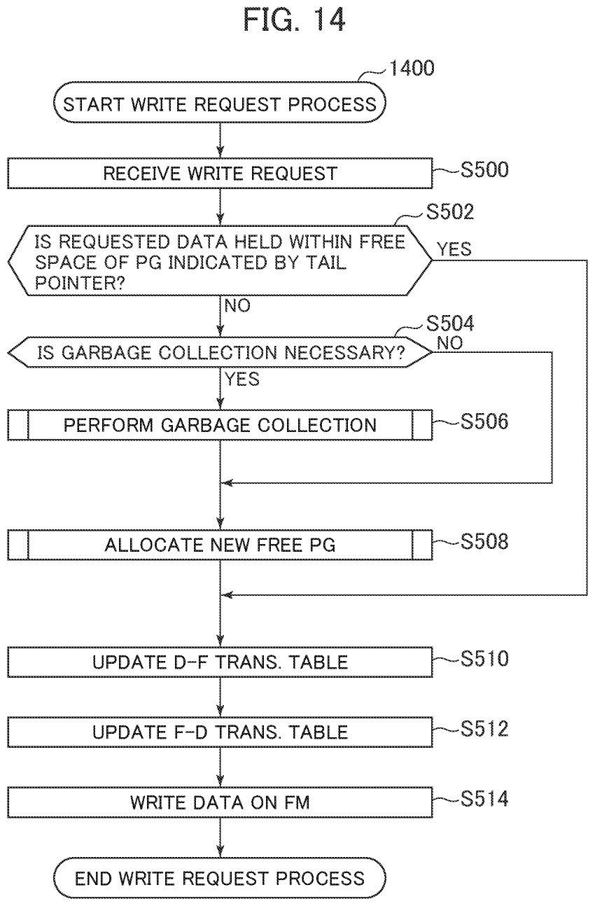

The procedure above can be expressed by a flowchart 1400 in FIG. 14 performed by the SSD controller 200. Note that the procedure is a sequence that is focused on the process of the relationship between the write request from the storage controller 104 and the address spaces, and is non-limiting to the order or the process content.

In Step S500, the SSD controller 200 receives a write request 410 from the storage controller 104 through the drive I/F 204.

In Step S502, it is determined whether the write-requested data fits into the free space of the PG indicated by the FM address tail pointer 701 based on the write size 412.

In the case in which the data fits into the free space, the procedure goes to Step S510.

In the case in which the data does not fit into the free space, the procedure goes to Step S504.

In Step S504, it is determined whether GC has to be performed. Examples of determination thresholds that can be considered include the case in which the used capacity of the SSD 105 is 90% or more, or the case in which the free capacity is 100 GB or less, for example. However, the other thresholds may be fine. The important thing here is to avoid the situations in which although there is a sufficient free capacity when the storage controller 104 sees the space, no new PG is allocated due to garbage.

In the case in which GC is unnecessary, the procedure goes to Step S508.

In the case in which GC is necessary, the procedure goes to Step S506.

Note that in the case in which the write request process is performed as the process in SSD GC, described later, it is determined that GC is unnecessary.

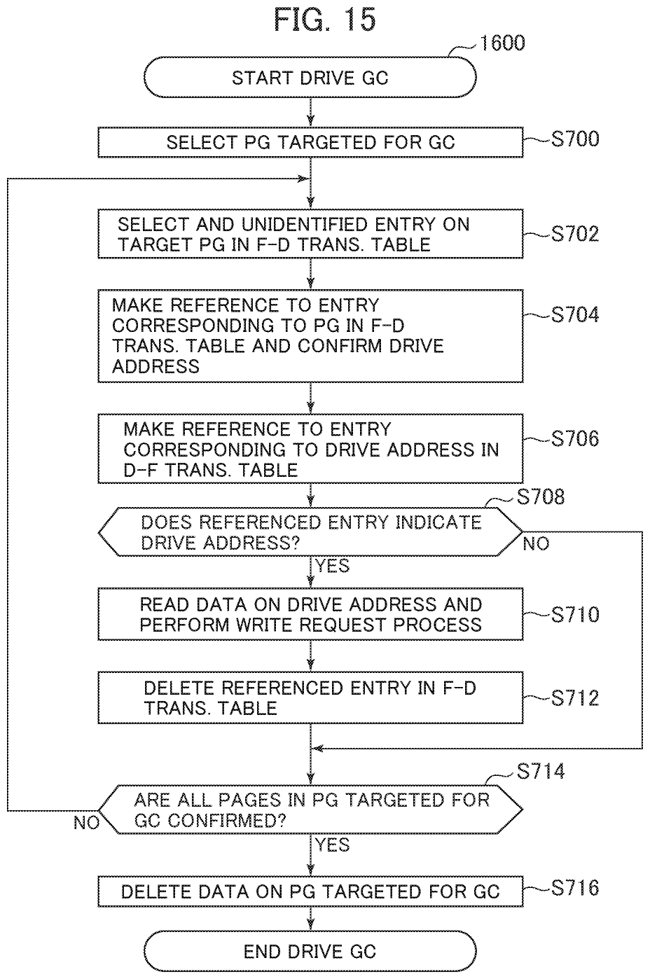

In Step S506, the SSD controller 200 performs GC. The detail of GC will be described in detail in a process 1600 shown in FIG. 15.

In Step S508, the SSD controller 200 allocates a new PG.

In Step S510, the D-F translation table 306 is updated.

Specifically, first, a row corresponding to the drive address 411 indicated by the write request 410 is selected from the drive address 810 in the D-F translation table 306. After that, the entries in the corresponding row are rewritten to the FM ID 820, the block ID 830, the page ID 840, and the page offset 850 corresponding to the FM address space 307 where the write is performed, indicated by the FM address tail pointer 701.

In Step S512, in order to update the F-D translation table 308, first, a new row is reserved on the F-D translation table 308. Subsequently, the FM ID 910, the block ID 920, the page ID 930, and the page offset 940 corresponding to the drive address space 305 indicated by the FM address tail pointer 701 and the drive address indicated by the write request are written to the row reserved in the F-D translation table 308.

In Step S514, data is written to the FM address written in Step S510 through the flash I/F.

### <GC Process Flow of the SSD>

GC on the SSD 105 corresponds to GC on the storage controller 104 in which segment, the H-C translation table 301 and the C-H translation table 303 are replaced by PG, the D-F translation table 306 and the F-D translation table 308, respectively.

The process may be performed at a given timing even in the case in which no request is made from the storage controller 104, in addition to the write request by the SSD controller 200. In the following, SSD GC (drive GC) will be described using the flowchart 1600 in FIG. 15.

In Step S700, the SSD controller 200 selects a PG that is a GC target. Examples of selecting the target PG that can be considered include a method that a PG is checked from the beginning of the drive address space 305 and if the ratio of garbage to all the spaces in the PG is 10% or more, the PG is selected, for example. However, the other algorithms may be used.

In Step S702, the SSD controller 200 selects an unchecked entry since drive GC is started on the PG selected in S700 in the F-D translation table 308.

In Step S704, the SSD controller 200 makes reference to the entry selected in Step S702, and refers the drive address field 840.

In Step S706, the SSD controller 200 selects the entry corresponding to the drive address referred in Step S704 in the D-F translation table 306.

In Step S708, the SSD controller 200 makes reference to the entry selected in Step S706, and refers the FM ID 910, the block ID 920, the page ID 930, and the page offset 940 that express the FM address.

When the referred FM address is matched with the FM address of the entry selected in Step S702, data stored on the FM address is valid, and the procedure goes to Step S710.

When the referred FM address is not matched with the FM address of the entry selected in Step S702, data stored on the referred FM address is garbage, and the procedure goes to Step S712.

In Step S710, the SSD controller 200 reads data stored on the FM address of the entry selected in Step S702, and performs the write request process 1400.

In Step S712, the SSD controller 200 deletes the entry selected in Step S702 in the F-D translation table 308. The entries in the F-D translation table 308 may also be collectively deleted the units of GC target PGs.

In Step S714, the SSD controller 200 checks whether the entry of the GC target segment selected in Step S700 is present in the F-D translation table 308.

In the case in which the entry is present, the procedure returns to Step S702.

In the case in which no entry is present, the procedure goes to Step S716.

In Step S716, the SSD controller 200 issues a data erase command to the blocks in the FMs in the GC target PGs.

### <Previously Existing Technique>

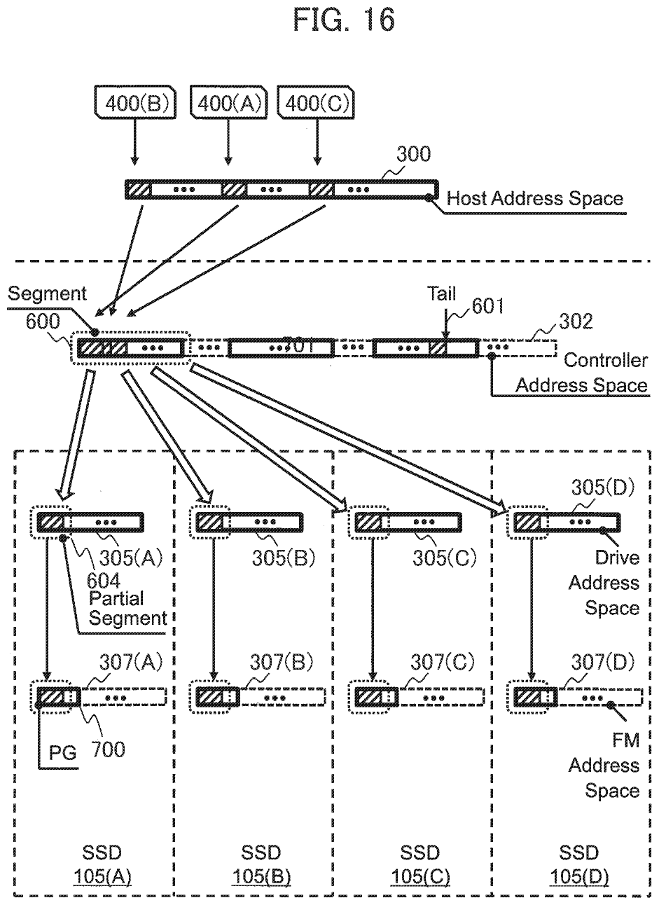

In order to further understanding the first embodiment of the present invention, FIG. 16 is a schematic diagram of address mapping in a previously existing technique. In a storage controller 104, the size of a segment 600 is determined according to various functions of the storage controller, such as the specifications of Thin Provisioning, for example. On the other hand, in an SSD 105, the size of a PG 700 depends on the FM block size. The number of SSDs 105 that form an RG has many options (in the first embodiment, four SSDs that are the SSD 105(A) to the SSD 105(D)). Therefore, when one segment 600 is allocated to a certain RG, the number of partial segments 604 allocated to one SSD is varied. In the schematic diagram in FIG. 16, the partial segment 604 is mapped as a part of the PG 700 in the SSDs. That is, at least two partial segments 604 can be presented in one PG.

For example, when the size of the segment 600 managed by the storage controller 104 is 42 MB, the size of the partial segment 604 in four SSDs 105(A) to 105(D) that form an RG is 14 MB derived from 42/3. Since one SSD that forms the RG stores parity data, the capacity of three SSDs 105 is substantially mapped on a host address space 300 on which the segment is mapped.

On the other hand, since the size of the PG 700 is configured of the block unit of an FM 201, the size is constrained to an integral multiple of a 4 MB block, i.e., the number of FMs configuring the PG 700. For example, in the case in which a PG includes five FMs in a 4D+1P configuration, the size of the PG 700 is 20 MB derived from 4 MB×4.

As described above, the size of the segment (14 MB) that is managed by the storage controller 104 and is the unit of GC by the storage controller 104 is different from the size of the PG (20 MB) that is managed by the SSD 105 and is the GC unit of the SSD controller 200. Thus, a part of the PG corresponds to the partial segment as shown in FIG. 16.

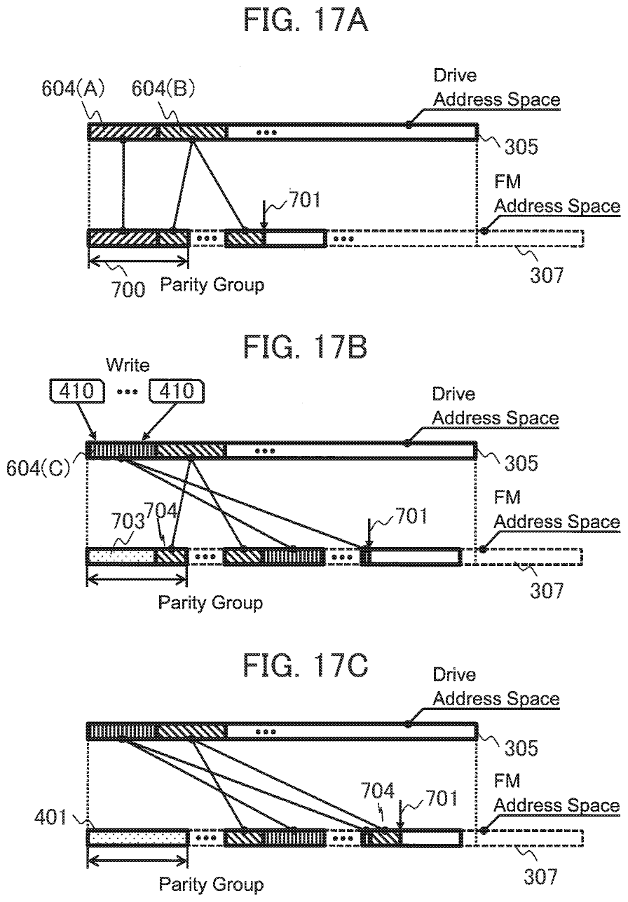

FIGS. 17A to 17C are diagrams illustrating mapping between the drive address space 305 and the FM address space 307 when data is overwritten in the reuse of the segment by the storage controller 104 and GC in the SSD produced later.

FIG. 17A is the state in which partial segments 604(A) and 604(B) are written to the drive address space 305. The partial segment 604(A) corresponds to one PG, and the partial segment 604(B) corresponds to two PGs. As shown in FIG. 17B, the storage controller 104 issues one or more write requests 410 to the corresponding address of the partial segment 604(A) in order to reuse it. In the stage in which the corresponding address is entirely overwritten, only a part of PG to which the mapped old data belongs is turned to drive garbage 703. As shown in FIG. 17C, in the stage in which the SSD controller 200 performs GC on the PG, the partial segment 604(B) contains valid data 704 that is different from the reused one, and hence data migration occurs.

For example, in the case in which the size of the partial segments 604(A) and 604(B) is 14 MB and the PG size is 20 MB, in the PG in FIG. 17B, 6 MB of the valid data 704 of the partial segment 604(B) remains other than the partial segment 604(A). Thus, as shown in FIG. 17C, the valid data 704 is migrated to the address subsequent to the FM address tail pointer 701. As described above, in GC for the PG 700, the partial segment size in the drive address space does not correspond to the PG size, and hence data migration due to GC occurs.

### <Procedure of Creating a New Segment According to the First Embodiment>

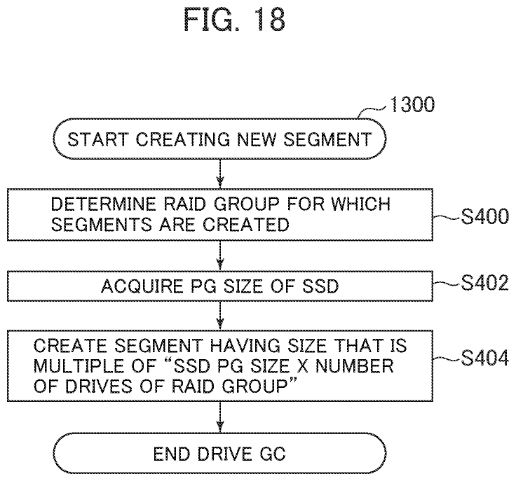

In the first embodiment, when the storage controller 104 allocates a new segment 600, a process flow 1300 in FIG. 18 is performed. In the following, the detail is shown.

In Step S400, an RG in which a segment 600 is created is determined.

In Step S402, the storage controller 104 acquires the PG size of the SSD 105 that belongs to the RG determined in Step S400. Examples of methods of acquiring the PG size include hardcoding the PG size on a control program in advance, creating a unique I/F with the host computer 101 to receive a notification, and creating a unique I/F with the drive to receive a notification, for example. However, the other methods may be used.

In Step S404, a segment 600 having a size that is a multiple of “the PG size of the SSD 105 acquired in Step S402×RG drive number” is created. Note that “the PG size” and “the number of the drives of the RAID group” here are both an actual capacity except the size of error-correcting code.

By providing the function to the storage controller 104, the storage controller 104 prevents valid data from migration when GC is performed on the SSD 105. Note that, the PG is a set including at least one given block of the FM. The set is provided because data erase in SSD GC is performed in block units due to the physical constraints of the FM. That is, the PG size is determined by configuring a PG in the FM block size and determined according to the number of FMs corresponding to the actual capacity. For example, in the case in which the PG takes a 5D+1P configuration, the FM number is “5”, and the PG size is 5× the block size. In the case in which the block size is 4 MB, the PG size is 20 MB.

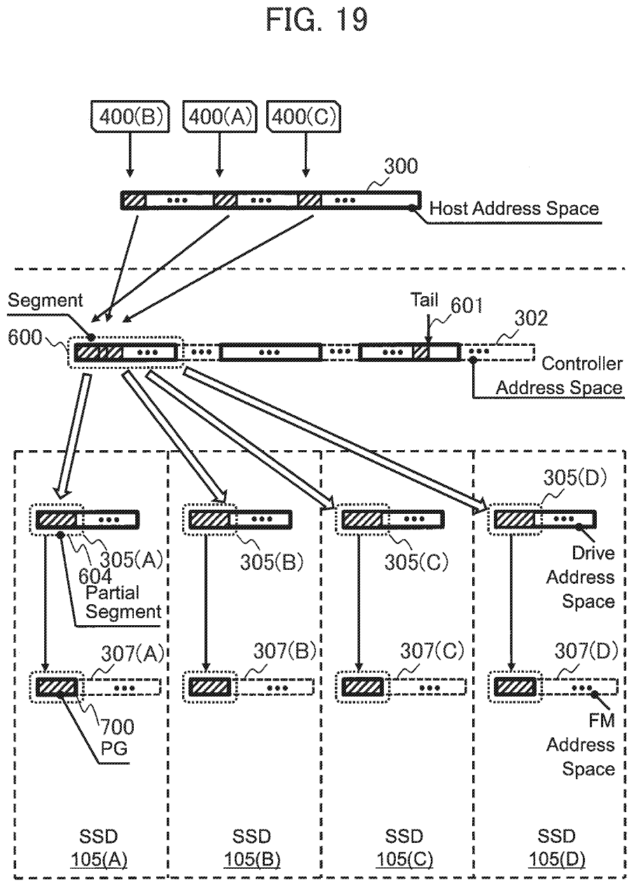

FIG. 19 is a schematic diagram. A segment is created according to the process flow 1300, and hence the size of the partial segment 604 distributed on the SSDs 105 is a multiple of the size of the PG 700. As a result, the PGs of the SSD 105 hold one partial segment at most.

For example, suppose that the PG size acquired in Step S402 in FIG. 18 is 20 MB. This case falls on the case in which the PG 700 is formed in a 5D+1P configuration, for example, and the size of the PG 700 is 20 MB (4 MB block×5). The partial segment 604 in the drive address space 305 mapped in the controller address space 302 only has to be 20 MB corresponding to the size of the PG 700. When the RAID group determined in Step S400 in FIG. 18 has a 3D+1P configuration, for example, the partial segment 604 having 20 MB has to be configured and the size of the segment in the controller address space 302 has to be 60 MB.

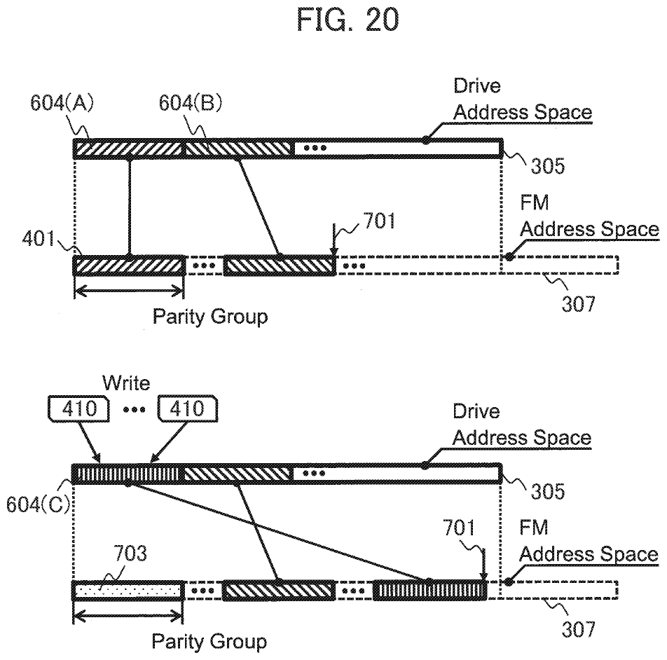

FIG. 20 is a diagram of mapping between the drive address space 305 and the FM address space 307 when the storage controller 104 overwrites data in order to reuse a segment. Similarly to FIGS. 17A to 17C, the storage controller 104 issues one or more write requests 410 to the corresponding address of the partial segment 604(A) in order to reuse it. After the corresponding address is entirely overwritten, the old mapped data entirely consumes the PG to which the data belongs. Therefore, in the stage in which the SSD controller 200 performs GC on the PG, the PG has no valid data and entirely has the drive garbage 703, and hence no data migration occurs.

Note that in the transient state in which data in a certain PG is overwritten on the drive address space 305, and if the PG is selected as a GC target, the PG at that point in time has both drive garbage 703 and valid data and hence data migration occurs. However, the PG in the transient state is not actually selected. This is because the FM address space 307 is wider than the drive address space 305 due to over-provisioning, and a PG having garbage in the entire space or an unused PG are always present.

As described above, in the first embodiment, the size of the segment of the storage controller is set to the PG size, i.e., an integral multiple of the FM block of the SSD, and hence data migration can be prevented from occurring in SSD GC. That is, the segment of the storage controller is the GC unit for the storage controller, and the PG size is GC unit for the SSD.

Therefore, for example, a reduction in data migration due to garbage collection enables an increase in the lifetime of the SSD, and a reduction in error correction process due to degradation of the SSD enables the improvement of performances as well.

### Second Embodiment

In a second embodiment, the case is described in which the FM address space 307 is not over-provisioned in the SSD 105 according to the first embodiment. No over-provisioning is performed, and hence a storage controller 104 can use the entire capacity of FMs installed on an SSD 105. In this case, however, in order to grasp the entire capacity of the SSD 105, the storage controller 104 issues a command to SSDs to disclose the entire capacity. In response to the capacity disclosure command, the SSDs 105 notifies their capacities to the storage controller 104.

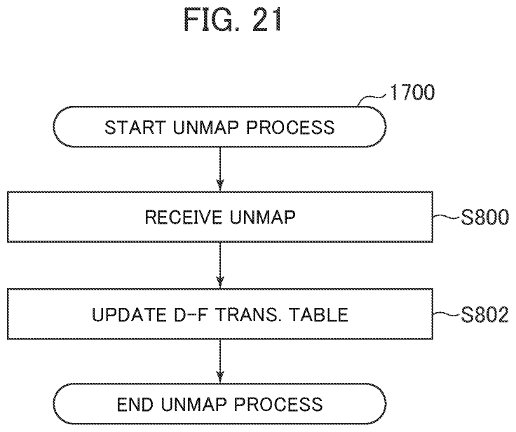

When the storage controller 104 does not notify the SSD 105 of the result of controller GC, garbage is produced due to overwrites to the SSD 105 by the storage controller 104, resulting in a shortage of the capacity of the SSD 105. Therefore, an UNMAP command is issued in controller GC, and free spaces recognized by the storage controller 104 and the SSD 105 are synchronized. In the following, an unmapping process of the SSD will be described using a flowchart 1700 in FIG. 21.

### <UNMAP Process of the SSD>

In Step S800, an SSD controller receives an UNMAP command from the storage controller 104 through a drive I/F 204. The UNMAP command includes a drive address and a size.

In Step S802, the SSD controller updates a D-F translation table 306. Specifically, the SSD controller selects a row corresponding to the drive address indicated by the UNMAP command from the D-F translation table 306, and sets the FM address space of the corresponding row to an invalid value.

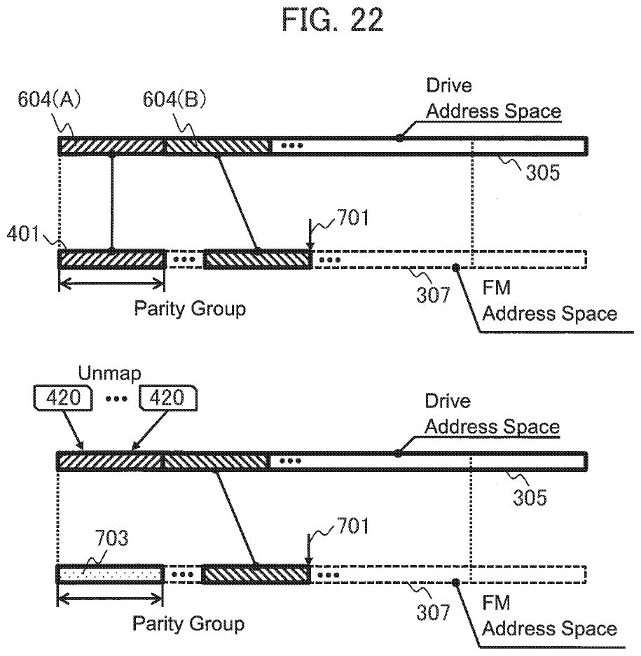

FIG. 22 shows mapping between a drive address space 305 and an FM address space 307 when an UNMAP command 420 is issued to the SSD 105 in GC by the storage controller 104. Similar to FIG. 20, when the storage controller 104 is to reuse a partial segment 604(A), mapped old data entirely uses a PG to which the old data belongs. Therefore, the UNMAP command is issued to the entire PG, and hence GC is done without data migration. Thus, even though the storage controller 104 issues a new write request, spare spaces are unnecessary.

For example, when the partial segment 604(A) in the drive address space 305 receives multiple write the requests 420, new write data is written to a new PG based on an FM address tail pointer 701, and the old data is drive garbage 703. The PG allocated to the partial segment 604(A) is released by the UNMAP command.

According to the second embodiment, over-provisioning is not performed, and hence the storage controller 104 can use the entire capacity of FMs installed on the SSD 105.

What is claimed is:

1. An information processing apparatus comprising:
a storage controller; and
a storage device,
wherein the storage controller manages a first address space in which data is recorded in a log-structured format in response to a write request from a host,
the storage device manages a second address space in which data is recorded in a log-structured format in response to a write request from the storage controller, and
the storage controller sets a unit by which the storage controller performs garbage collection in the first address space to a multiple of a unit by which the storage device performs garbage collection in the second address space.

2. The information processing apparatus according to claim 1, wherein the storage controller issues, to the storage device, a command to notify a space that is empty by garbage collection in performing garbage collection on the first address space.

3. The information processing apparatus according to claim 1,
wherein the storage controller requests the storage device to send a unit by which garbage collection is performed,
the storage device replies to the request by the storage controller about a unit by which garbage collection is performed, and
the storage controller determines a unit by which garbage collection is performed based on the reply.

4. The information processing apparatus according to claim 2,
wherein the storage controller requests the storage device to send a unit by which garbage collection is performed,
the storage device replies to the request by the storage controller about a unit by which garbage collection is performed, and
the storage controller determines a unit by which garbage collection is performed based on the reply.

5. The information processing apparatus according to claim 1, wherein the storage device discloses a storage area of the storage device to the storage controller.

6. An information processing apparatus comprising:
a storage controller; and
at least two storage devices,
wherein the storage controller has a first address space in which data is recorded in a log-structured format in response to a write request from a host, the first address space being managed in a segment unit,
the storage device has a second address space in response to a write request from the storage controller in which data is recorded in a log-structured format, the second address space being managed in a parity group unit,
in the first address space, the storage controller performs garbage collection in the segment unit, and in the second address space, the storage device performs garbage collection in a unit of the parity group, and
the storage controller sets the segment unit to a multiple of the unit of the parity group.

7. The information processing apparatus according to claim 6,
wherein the storage device has at least two flash memories,
a size of the parity group managed by the storage device is a multiple of an erase unit for the at least two flash memories, and
a size of a segment managed by the storage controller is a multiple of the erase unit for the at least two flash memories.

8. The information processing apparatus according to claim 7, wherein the storage controller issues, to the storage device, a command to notify a space that is empty by garbage collection in performing garbage collection on the first address space.

9. The information processing apparatus according to claim 7,
wherein the storage controller requests the storage device to send a unit by which garbage collection is performed,
the storage device replies to the request by the storage controller about a unit by which garbage collection is performed, and
the storage controller determines a unit by which garbage collection is performed based on the reply.

10. A control method for a storage space of an information processing apparatus having a storage controller and at least two storage devices, the method comprising:
managing, by the storage controller, a first address space in which data is recorded in a log-structured format in response to a write request from a host;
managing, by the storage device, a second address space in which data is recorded in a log-structured format in response to a write request from the storage controller; and
setting, by the storage controller, a unit by which the storage controller performs garbage collection in the first address space to a multiple of a unit by which the storage device performs garbage collection in the second address space.

11. The control method according to claim 10, wherein the storage controller issues, to the storage device, a command to notify a space that is empty by garbage collection in performing garbage collection on the first address space.

12. The control method according to claim 10,
wherein the storage controller requests the storage device to send a unit by which garbage collection is performed,
the storage device replies to the request by the storage controller about a unit by which garbage collection is performed, and
the storage controller determines a unit by which garbage collection is performed based on the reply.

13. The control method according to claim 10,
wherein the storage controller has a first address space in which data is recorded in a log-structured format in response to a write request from a host, the first address space being managed in a segment unit,
the storage device has a second address space in response to a write request from the storage controller in which data is recorded in a log-structured format, the second address space being managed in a parity group unit,
in the first address space of the storage controller, garbage collection is performed in the segment unit, and in the second address space of the storage device, garbage collection is performed in a unit of the parity group, and
the storage controller sets the segment unit to a multiple of the unit of the parity group.

14. The control method according to claim 13,
wherein the storage device has at least two flash memories,
a size of the parity group managed by the storage device is a multiple of an erase unit for the at least two flash memories, and
a size of a segment managed by the storage controller is a multiple of the erase unit for the at least two flash memories.

15. The control method according to claim 13, wherein the storage controller issues, to the storage device, a command to notify a space that is empty by garbage collection in performing garbage collection on the first address space.
